(19) United States
(12) Patent Application Publication
(10) Pub. No.: US 2009/0322847 A1
(43) Pub. Date: Dec. 31, 2009

(54) Exposure device, LED head, image forming apparatus, and reading apparatus

(75) Inventor: Akihiro Yamamura, Tokyo (JP)

Correspondence Address: Kubotera & Associates, LLC, 200 Daingerfield Rd, Suite 202, Alexandria, VA, 22314, US

(73) Assignee: Oki Data Corporation

(21) Appl. No.: 12/453,960

(22) Filed: May 28, 2009

(30) Foreign Application Priority Data
Jun. 27, 2008 (JP) 2008-168904

(51) Int. Cl. B41J 2/385

(52) U.S. Cl. 347/130

(57) ABSTRACT

An exposure device includes a light emitting portion array formed of a plurality of light emitting portions and a lens array including lens assembly members formed of lenses and a light blocking member. The light emitting portions are arranged linearly with a specific interval PD. The light emitting portion array and the lens array are arranged so that when light in parallel to the optical axis of one of the lenses is incident to the lens from a direction of the light blocking member, the lens forms a spot having a radius RS satisfying the following relationship:

$$RS < \frac{PD \cdot FO}{2 LO}$$

where FO is a focal length of the lens, LO is a distance between the lens and the light emitting portion array, and FO is a distance between the lens and a plane where the spot is formed on a side of the light emitting portions.

### BACKGROUND OF THE INVENTION AND RELATED ART STATEMENT

The present invention relates to an exposure device; an LED (Light Emitting Diode) head; an image forming apparatus; and a reading apparatus.

A conventional image forming apparatus of an electro-photography type such as a printer include an exposure device. The exposure device includes an LED (Light Emitting Diode) head as a light emitting portion provided with a plurality of LEDs arranged in an array pattern, so that the LED head forms an exposure image on a photosensitive member.

In the conventional image forming apparatus or the conventional reading apparatus with the exposure device described above, a lens array as an optical system is provided with a plurality of lenses arranged therein for forming an image in a linear arrangement.

The lens array may be provided with a rod lens. The rod lens is formed of a glass fiber implanted with ions to have a refractive index decreasing from a center portion thereof toward a peripheral portion thereof. When the lens array is formed of the rod lens, it is difficult to produce the lens array with a low cost manufacturing facility. Further, it is difficult to form an image with a high resolution.

As another configuration, a plurality of micro lenses is arranged in an array to form a lens array. It is possible to efficiently produce the lens array formed of the micro lenses through plastic injection molding. Further, it is possible to form an image with a high resolution. (refer to Patent Reference).

Patent Reference: Japanese Patent Publication No. 2000-221445

In the lens array formed of the micro lenses, when the micro lenses have various optical properties, the lens array tends to form an image with a streak or an uneven spot. In order to produce the micro lenses having a uniform optical property, it is necessary to accurately prepare an injection molding mold having an identical curve surface. In an actual case, it is difficult to have an identical curve surface for all micro lenses. Further, it is necessary to maintain a constant distance between the lens array and an object plane and a constant distance between the lens array and an image plane, thereby requiring high accuracy in installation positions of components.

In view of the problems described above, an object of the present invention is to provide an exposure device, an image forming apparatus, and a reading apparatus capable of forming an image with a high resolution even when accuracy of a lens shape or installation positions of components is lowered.

Further objects and advantages of the invention will be apparent from the following description of the invention.

### SUMMARY OF THE INVENTION

In order to attain the objects described above, according to a first aspect of the present invention, an exposure device includes a light emitting portion array formed of a plurality of light emitting portions and a lens array including a plurality of lens assembly members and at least one light blocking member. The lens assembly members are arranged substantially in parallel to the light emitting portion array. The light blocking member is arranged between the lens assembly members.

In the light emitting portion array, the light emitting portions are arranged substantially linearly with a specific interval PD in between. In the lens array, each of the lens assembly members is formed of a plurality of lenses arranged in a direction perpendicular to optical axes thereof, so that the optical axes of the lenses are aligned with those of lenses of an adjacent lens assembly member arranged to face the lenses. The light blocking member includes a plurality of apertures arranged such that an optical axis of a pair of the lenses of two adjacent lens assembly members facing each other passes through each of the apertures.

Further, the light emitting portion array and the lens array are arranged so that when light in parallel to the optical axis of one of the lenses is incident to the one of the lenses from a direction of the light blocking member, the one of the lenses forms a spot having a radius RS satisfying the following relationship:

$$RS < \frac{PD \cdot FO}{2 LO}$$

where FO is a focal length of the one of the lenses, LO is a distance between the one of the lenses and the light emitting portion array, and FO is a distance between the one of the lenses and a plane where the spot is formed on a side of the light emitting portions.

According to a second aspect of the present invention, an image forming apparatus includes the exposure device in the first aspect of the present invention.

According to a third aspect of the present invention, an LED head includes an LED array formed of a plurality of LED elements and a lens array including a plurality of lens assembly members and at least one light blocking member. The lens assembly members are arranged substantially in parallel to the LED array. The light blocking member is arranged between the lens assembly members.

In the LED array, the LED elements are arranged substantially linearly with a specific interval PD in between. In the lens array, each of the lens assembly members is formed of a plurality of lenses arranged in a direction perpendicular to optical axes thereof, so that the optical axes of the lenses are aligned with those of lenses of an adjacent lens assembly member arranged to face the lenses. The light blocking member includes a plurality of apertures arranged such that an optical axis of a pair of the lenses of two adjacent lens assembly members facing each other passes through each of the apertures.

Further, the LED array and the lens array are arranged so that when light in parallel to the optical axis of one of the lenses is incident to the one of the lenses from a direction of the light blocking member, the one of the lenses forms a spot having a radius RS satisfying the following relationship:

$$RS < \frac{PD \cdot FO}{2 LO}$$

where FO is a focal length of the one of the lenses, LO is a distance between the one of the lenses and the LED array, and FO is a distance between the one of the lenses and a plane where the spot is formed on a side of the LED elements.

According to a fourth aspect of the present invention, an image forming apparatus includes the LED head in the third aspect of the present invention.

According to a fifth aspect of the present invention, an reading apparatus includes a line sensor formed of a plurality of light receiving elements and a lens array including a plurality of lens assembly members and at least one light blocking member. The lens assembly members are arranged substantially in parallel to the line sensor. The light blocking member is arranged between the lens assembly members.

In the line sensor, the light receiving elements are arranged substantially linearly with a specific interval PR in between. In the lens array, each of the lens assembly members is formed of a plurality of lenses arranged in a direction perpendicular to optical axes thereof, so that the optical axes of the lenses are aligned with those of lenses of an adjacent lens assembly member arranged to face the lenses. The light blocking member includes a plurality of apertures arranged such that an optical axis of a pair of the lenses of two adjacent lens assembly members facing each other passes through each of the apertures.

Further, the line sensor and the lens array are arranged so that when light in parallel to the optical axis of one of the lenses is incident to the one of the lenses from a direction of the light blocking member, the one of the lenses forms a spot having a radius RS satisfying the following relationship:

$$RS < \frac{PR \cdot FO}{2 LO}$$

where FO is a focal length of the one of the lenses, LO is a distance between the one of the lenses and the Line sensor, and FO is a distance between the one of the lenses and a plane where the spot is formed on a side of the light receiving elements.

As described above, in the exposure device, the LED head, and the reading apparatus in the present invention, the lenses form spots having a radius smaller than a specific value. Accordingly, even when the lenses of the lens array have various optical properties, or have the optical axes not exactly extending in parallel, it is possible to form an image with a sufficient resolution. As a result, even when accuracy of a lens shape or install positions of components is lowered, it is possible to produce the lenses and the lens assembly members with high productivity. Further, with the image forming apparatus having the exposure device or the LED head described above, it is possible to form an image without a streak or an uneven spot.

### BRIEF DESCRIPTION OF THE DRAWINGS

FIG. 1 is a schematic view No. 1 showing a configuration of an LED (Light Emitting Diode) head according to a first embodiment of the present invention;

FIG. 2 is a schematic view No. 2 showing the configuration of the LED head according to the first embodiment of the present invention;

FIG. 3 is a schematic view No. 3 showing the configuration of the LED head according to the first embodiment of the present invention;

FIG. 4 is a schematic sectional view showing a printer according to the first embodiment of the present invention;

FIG. 5 is a schematic sectional view showing the LED head according to the first embodiment of the present invention;

FIG. 6 is a schematic sectional view showing a lens array taken along a line 6-6 in FIG. 7 according to the first embodiment of the present invention;

FIG. 7 is a schematic plan view showing a lens plate viewed from a direction A in FIG. 6 according to the first embodiment of the present invention;

FIG. 8 is a schematic plan view showing a light blocking member according to the first embodiment of the present invention;

FIG. 9 is a schematic view showing an opening portion of the light blocking member according to the first embodiment of the present invention;

FIGS. 10(a) and 10(b) are schematic views showing micro lenses of the lens array according to the first embodiment of the present invention;

FIGS. 11(a) and 11(b) are schematic views showing a focal length measurement device;

FIG. 12 is a schematic view showing an optical property evaluation system;

FIG. 13 is a graph showing a brightness distribution of a spot formed on an evaluation plane;

FIG. 14 is a schematic view showing an evaluation pattern;

FIG. 15 is a schematic view showing a configuration of an LED head according to a second embodiment of the present invention;

FIG. 16 is a schematic view showing a configuration of a scanner according to a third embodiment of the present invention;

FIG. 17 is a schematic view showing a reading head of the scanner according to the third embodiment of the present invention; and

FIG. 18 is a schematic view showing an optical system of the scanner according to the third embodiment of the present invention.

### DETAILED DESCRIPTION OF PREFERRED EMBODIMENTS

Hereunder, preferred embodiments of the present invention will be explained with reference to the accompanying drawings.

### First Embodiment

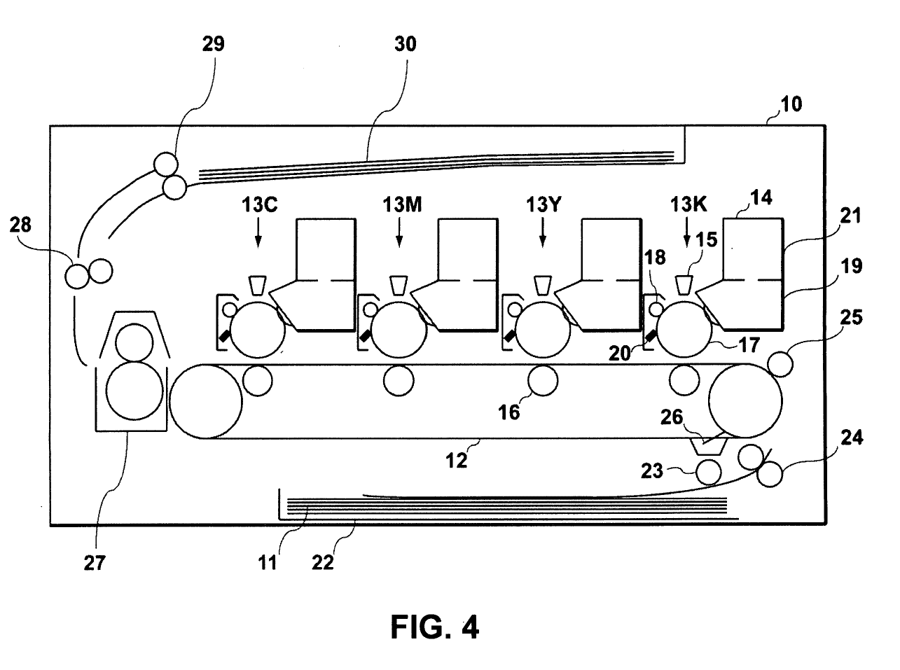

A first embodiment of the present invention will be explained. FIG. 4 is a schematic sectional view showing a configuration of a printer 10 according to the first embodiment of the present invention. The printer 10 is an image forming apparatus of an electro-photography type, and includes an LED (Light Emitting Diode) head 15 as an exposure device. The printer 10 is configured to overlap toner in colors, thereby forming a color image according to image data.

As shown in FIG. 4, the printer 10 includes four separate printer mechanisms 13K, 13Y, 13M, and 13C sequentially arranged along a moving direction of a transfer belt 12 constituting a transport path for transporting a sheet 11. The printer mechanisms 13K, 13Y, 13M, and 13C are LED printer mechanisms of an electro-photography type corresponding to each color of black, yellow, magenta, and cyan.

In the embodiment, the printer mechanisms 13K, 13Y, 13M, and 13C have an identical configuration. In the following description, the printer mechanisms 13K, 13Y, 13M, and 13C are collectively referred to as printer mechanisms 13, except when it is necessary to differentiate an identical component of the printer mechanisms 13K, 13Y, 13M, and 13C, in which a character such as K, Y, M, and C is attached to a corresponding reference numeral.

In the embodiment, each of the mechanisms 13K, 13Y, 13M, and 13C includes an image forming unit 14 for forming a toner image; the LED head 15 as the exposure device; and a transfer roller 16 as a transfer device.

As shown in FIG. 4, a photosensitive drum 17 as a static latent image supporting member is disposed inside the image forming unit 14. There are disposed around the photosensitive drum 17 a charging roller 18 for supplying electric charges and charging a surface of the photosensitive drum 17; a developing device 19; and a cleaning blade 20 arranged to abut against the surface of the photosensitive drum 17. Further, a toner cartridge 21 is detachably disposed at an upper portion of the image forming unit 14. The toner cartridge 21 retains toner as developer formed of a resin containing a colorant as a coloring agent, so that toner is supplied from the toner cartridge 21 to the developing device 19.

In the embodiment, the LED head 15 as the exposure device irradiates the surface of the photosensitive drum 17 charged with the charging roller 18 according to image data, thereby forming a static latent image thereon. The developing device 19 develops the static latent image with toner, thereby forming a toner image on the surface of the photosensitive drum 17.

As shown in FIG. 4, the transfer roller 16 is disposed to face the photosensitive drum 17 with the transfer belt 12 for transporting the sheet 11 in between, so that the transfer roller 16 transfers the toner image formed on the surface of the photosensitive drum 17 to a surface of the sheet 11 thus transported. The cleaning blade 20 scrapes off and removes toner not transferred and remaining on the surface of the photosensitive drum 17.

In the embodiment, a sheet supply cassette 22 is disposed at a lower portion of the printer 10 for retaining the sheet 11 as a print medium. When a sheet supply roller 23 rotates, the sheet supply roller 23 picks up the sheet 11 in the sheet supply cassette 22, so that transport rollers 24 and 25 transport the sheet 11 to the transfer belt 12. The transfer belt 12 is disposed at a lower portion of the image forming unit 14. The transfer belt 12 is arranged to rotate in a state that an upper outer circumferential surface thereof abuts against the surface of the photosensitive drum 17, thereby sequentially transporting the sheet 11 to each of the printer mechanisms 13.

As shown in FIG. 4, a cleaning blade 26 is disposed below the transfer belt 12, so that a distal end portion of the cleaning blade 26 abuts against a lower outer circumferential surface of the transfer belt 12. When the transfer belt 12 rotates and moves, the cleaning blade 26 scrapes off and removes toner or dust attached to the outer circumferential surface of the transfer belt 12.

As shown in FIG. 4, a fixing device 27 is disposed on a downstream side in a direction that the transfer belt 12 transports the sheet 11. When the transfer belt 12 transports the sheet 11, the fixing device 27 applies heat and pressure to the sheet 11, so that the toner images in colors transferred with the printer mechanisms 13 are fixed to the sheet 11.

In the embodiment, a transport roller 28 is disposed on a downstream side of the fixing device 27 for transporting the sheet 11 to a discharge roller 29 after the sheet 11 passes through the fixing device 27. Then, the discharge roller 29 discharges the sheet 11 to a discharge portion 30. The discharge portion 30 is disposed at an upper portion of the sheet 11 for retaining the sheet 11 after the image is formed on the sheet 11.

In the embodiment, the printer 10 includes a power source (not shown) for applying a specific voltage to the discharge roller 18 and the transfer roller 16. Further, a motor and a gear for transmitting drive of the motor (not shown) are provided for driving each of the transfer belt 12, the photosensitive drum 17, and the rollers.

In the embodiment, the printer 10 includes a power source and a control unit (not shown) connected to each of the fixing device 27, the developing device 19, the LED head 15, and the motor. Further, the printer 10 includes an external interface unit for communicating with an external device and receiving the print data, and a control unit for receiving the print data from the external interface unit and controlling each of the components of the printer 10.

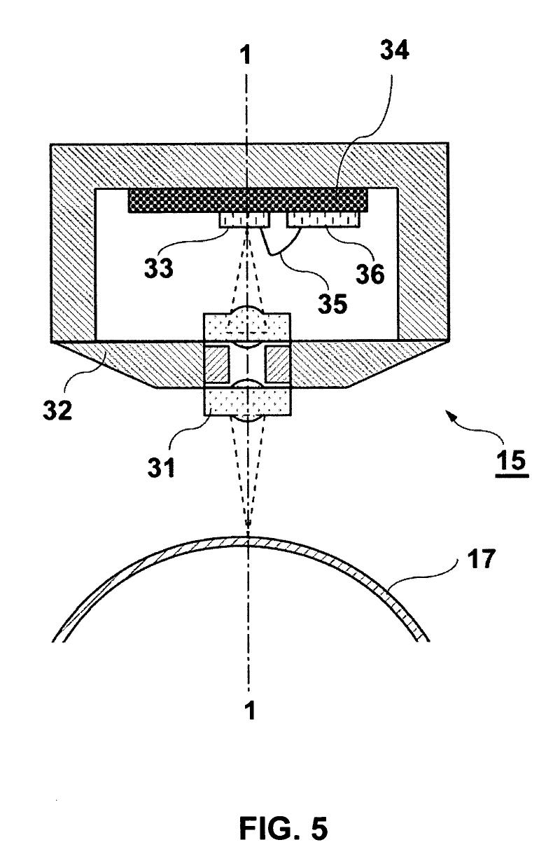

A configuration of the LED head 15 will be explained next. FIG. 5 is a schematic sectional view showing the LED head 15 according to the first embodiment of the present invention.

As shown in FIG. 5, the LED head 15 is provided with a lens array 31. The lens array 31 is fixed to the LED head 15 with a holder 32. A plurality of LED (Light Emitting Diode) elements 33 as light emitting portions is arranged in the holder 32. The LED elements 33 are linearly arranged on a circuit board 34 in one row with a specific interval PD in between. The specific interval or an arrangement interval PD of the LED elements 33 on the circuit board 34 is referred to as an arrangement pitch. A driver IC (Integrated Circuit) 36 is mounted on the circuit board 34, and is connected to the LED elements 31 through a wiring portion 35.

In the embodiment, the LED head 15 has a resolution of 600 dpi, and 600 of the LED elements 33 are arranged per one inch (equal to about 25.4 mm). That is, the LED elements 33 are arranged with the arrangement pitch PD of 0.0423 mm, thereby forming an LED array as a light emitting portion array. The LED head 15 drives the LED elements 33 to emit light. When light emitted from the LED elements 33 passes through the lens array 31, the LED elements 33 irradiate the surface of the photosensitive drum 17, so that a static latent image is formed thereon.

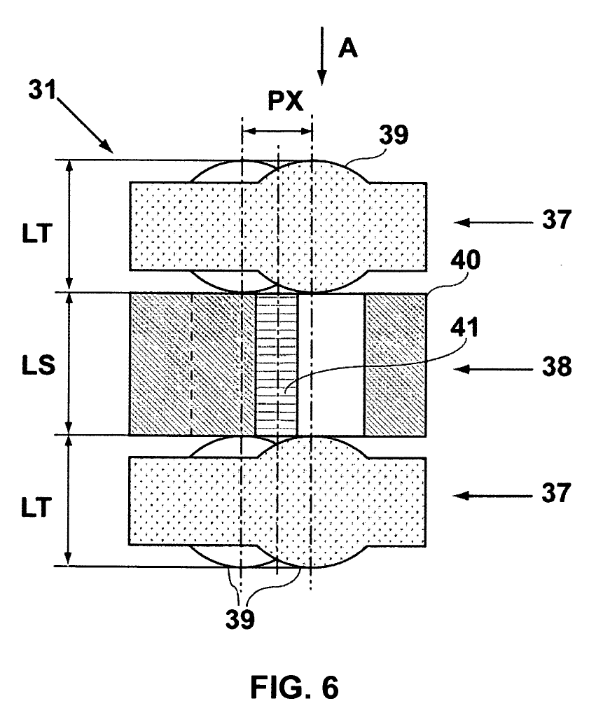

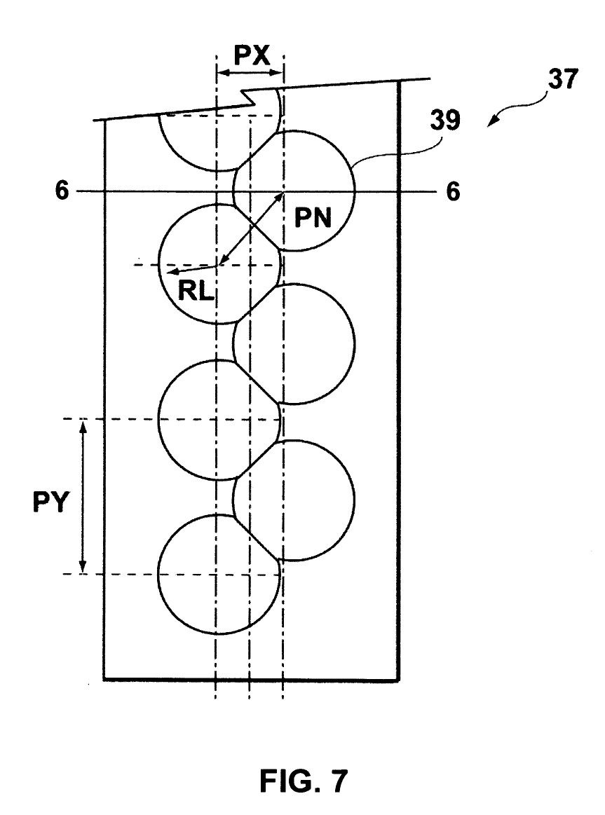

A configuration of the lens array 31 in the LED head 15 will be explained next. FIG. 6 is a schematic sectional view showing the lens array 31 taken along a line 6-6 in FIG. 7 according to the first embodiment of the present invention. As shown in FIG. 6, the lens array 31 includes two lens plates 37 as lens assembly members and one light blocking member 38 disposed between the lens plates 37.

FIG. 7 is a schematic plan view showing the lens plate 37 viewed from an arrow direction A in FIG. 6 according to the first embodiment of the present invention. As shown in FIG. 7, a plurality of micro lenses 39 is arranged in the lens plate 37, so that a main plane of each of the micro lenses 39 extends perpendicular to an optical axis of another of the micro lenses 39. More specifically, the micro lenses 39 are arranged such that the main planes thereof are situated on a same plane.

In the embodiment, the micro lenses 39 are arranged on the lens plate 37 in two rows with an arrangement interval PX in between. In each row, the micro lenses 39 are arranged with an arrangement interval PY in between along a longitudinal direction of the lens plate 37.

As shown in FIGS. 6 and 7, each of the micro lenses 39 has a thickness LT in the optical axis thereof, and is formed in a circular shape with a radius RL in a section thereof taken along the lens plate 37. Further, two adjacent micro lenses 39 are arranged such that a distance PN between centers of the circular shape of the two adjacent micro lenses 39 is smaller than double of the radius RL (PN<2×RL). More specifically, the two adjacent micro lenses 39 are arranged on the lens plate 37 such that two adjacent micro lenses 39 are partially overlapped with each other.

In the embodiment, in order to obtain a high degree of definition, each of the micro lenses 39 has a curved surface formed in a rotationally symmetrical high order aspheric surface expressed a function z(r) represented with the following equation (1):

$$z ( r ) = \frac{\frac{{r}^{2}}{C}}{1 + \sqrt{1 - {( \frac{r}{C} )}^{2}}} + {Ar}^{4} + {Br}^{6} \qquad ( 1 )$$

where a coordinate r is a rotational coordinate with the optical axis of each of the micro lenses 39 as an axis and a top of the curved surface of each of the micro lenses 39 as an origin. A positive number is assigned along a downward direction in FIG. 5, i.e., a direction from the LED element 33 toward the photosensitive drum 17. Further, in the equation (1), C is a curvature radius of the micro lenses 39, and A and B are a fourth aspheric coefficient and a sixth aspheric coefficient of the rotationally symmetrical high order aspheric surface, respectively

In the embodiment, the lens plate 37 is formed of a transparent material relative to light emitted from the LED elements 33. The lens plate 37 is formed of, for example, an optical resin of a cyclo-olefin type (ZEONEX E48R, a product of ZEON CORPORATION). It is possible to produce a plurality of the lens plates 37 through injection molding.

As shown in FIG. 6, in the lens array 31, the light blocking member 38 is disposed between the lens plates 37 in a state that the light blocking member 38 abuts against the top of the curved surface of each of the micro lenses 39. The light blocking member 38 has a thickness LS in the optical axis direction of the micro lenses 39. Further, the light blocking member 38 includes two comb shape members 40 and a section plate member 41 arranged between the comb shape members 40.

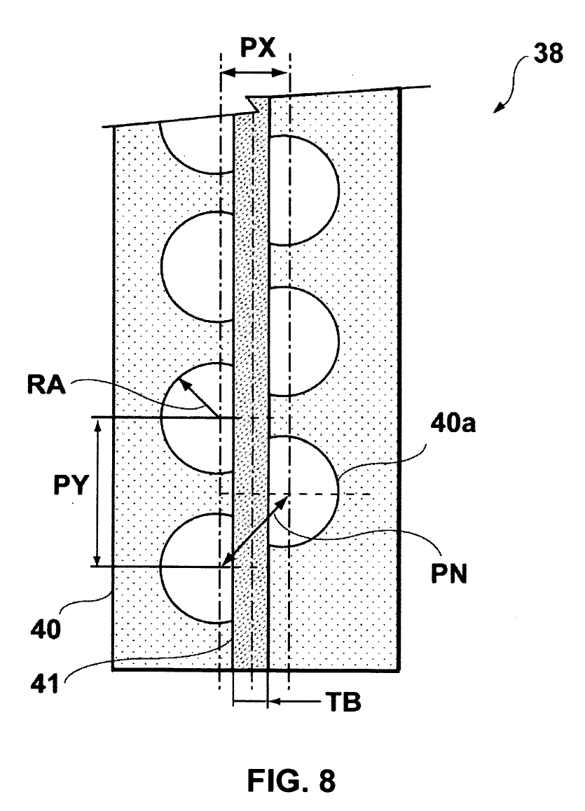

FIG. 8 is a schematic plan view showing the light blocking member 38 according to the first embodiment of the present invention. Similar to FIG. 7, FIG. 8 is a plane view showing the light blocking member 38 of the lens array 31 viewed from the arrow direction A in FIG. 6.

As shown in FIG. 8, the section plate member 41 has a width TB in a direction perpendicular to a longitudinal direction and a thickness direction of the lens array 31. Each of the comb shape members 40 has a plurality of opening portions 40a arranged with an interval PY. The comb shape members 40 are arranged such that the opening portions 40a correspond to the arrangement of the micro lenses 39 of the lens plates 37, thereby functioning as apertures of the micro lenses 39.

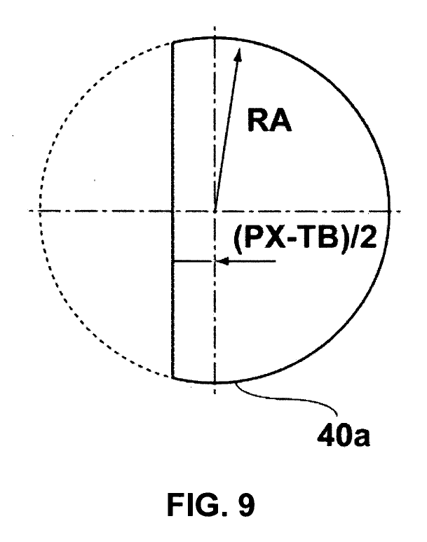

FIG. 9 is a schematic view showing the opening portion 40a of the light blocking member 40 according to the first embodiment of the present invention. As shown in FIG. 9, the opening portion 40a has a circular shape with a radius RA, and the circular shape is cut at a position away from a center of the circle by a distance (PX−TB)/2.

In the embodiment, the light blocking member 38 is formed of a transparent material relative to light emitted from the LED elements 33. The comb shape members 40 and the section plate member 41 of the light blocking member 38 are formed of, for example, polycarbonate through injection molding.

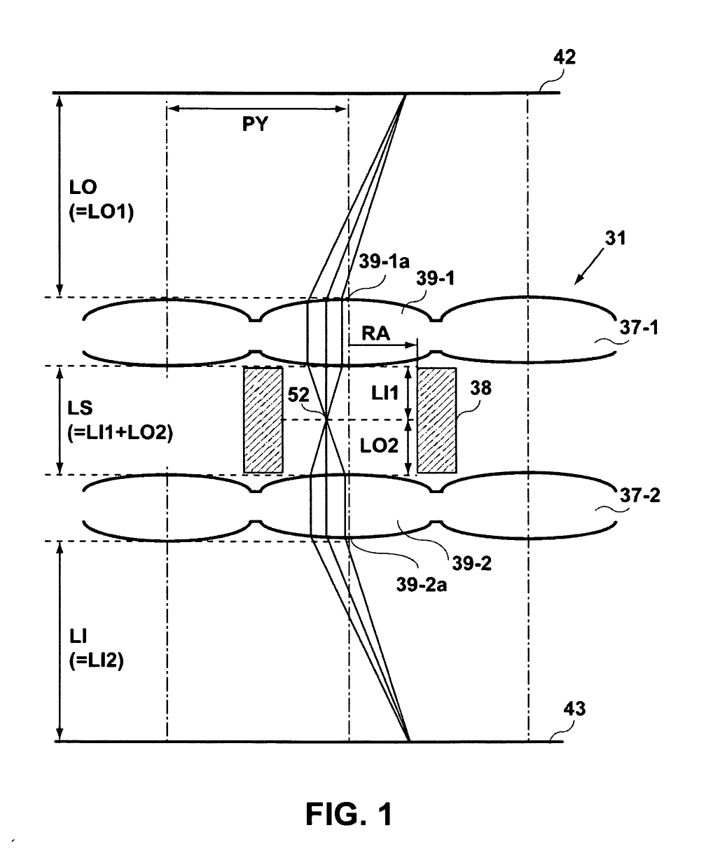

A configuration of the lens array 31 of the LED head 15 will be explained in more detail next. FIG. 1 is a schematic view No. 1 showing a configuration of the LED head 15 according to the first embodiment of the present invention. FIG. 1 is a sectional view of the LED head 15 taken along a line 1-1 in FIG. 5 with a plane passing through the optical axes of the micro lenses 39.

As shown in FIG. 5, the lens array 31 is disposed between the LED elements 33 arranged on the circuit board 34 and the photosensitive drum 17, so that light emitted from the LED elements 33 passes through the lens array 31 to form an image on the photosensitive drum 17. More specifically, as shown in FIG. 1, an arrangement plane of the light emitting portion array or the LED array in which the LED elements 33 are arranged corresponds to an object plane 42 of the lens array 31. The surface of the photosensitive drum 17 corresponds to an image plane 43 of the lens array 31. The object plane 42 and the image plane 43 are arranged in parallel to each other with the lens array 31 in between.

As described above, the lens array 31 is formed of the lens plates 37 and the light blocking member 38 (refer to FIG. 6). In FIG. 1, one of the lens plates 37 situated on a side of the object plane 42 is referred to as a first lens plate 37-1, and the other of the lens plates5515 37 situated on a side of the image plane 43 is referred to as a second lens plate 37-2.

In the lens array 31, the first lens plate 37-1 is formed of a plurality of micro lenses 39-1, and the second lens plate 37-1 is formed of a plurality of micro lenses 39-2 in a number the same as that of the micro lenses 39-1. The first lens plate 37-1 and the second lens plate 37-2 are produced using a same mold, and have an identical shape. As shown in FIG. 1, the first lens plate 37-1 and the second lens plate 37-2 are arranged away from each other by a distance LS such that optical axes of the micro lenses 39-1 are aligned with those of the micro lenses 39-2.

As shown in FIG. 1, the first lens plate 37-1 is arranged at a position away from the object plane 42 by a distance LO in parallel to the object plane 42. The distance LO represents a distance between the object plane 42 and a top of a curved surface 39-1a of each of the micro lenses 39-1. The optical axis of each of the micro lenses 39-1 extends in a direction perpendicular to the object plane 42. The micro lenses 39-1 of the first lens plate 37-1 have a thickness LT in an optical axis direction thereof, and a focal length FO. The micro lenses 39-1 are arranged to form an image of an object situated at a distance LO1 forward in the optical axis direction on a plane at a distance LI1 backward in the optical axis direction.

As shown in FIG. 1, the second lens plate 37-2 is arranged at a position away from the image plane 43 by a distance LI in parallel to the image plane 43. More specifically, the first lens plate 37-1, the second lens plate 37-2, the object plane 42, and the image plane 43 are arranged in parallel to each other. The distance LI represents a minimum distance between the image plane 43 and a top of a curved surface 39-2a of each of the micro lenses 39-2. The micro lenses 39-2 of the second lens plate 37-2 have a thickness LT in an optical axis direction thereof, and a focal length FI. The micro lenses 39-2 are arranged to form an image of an object situated at a distance LO2 forward in the optical axis direction on a plane at a distance LI2 backward in the optical axis direction.

As described above, light emitted from the LED elements 33 or the object plane 42 passes through the lens array 31, thereby forming an image on the image plane 43. Accordingly, the distance LO1 is equal to the distance LO between the first lens plate 37-1 and the object plane 42 (LO1=LO). Similarly, the distance LI2 is equal to the distance LI between the second lens plate 37-2 and the image plane 43 (LI2=LI).

Further, the micro lenses 39-1 of the first lens plate 37-1 form an intermediate image 52, and the micro lenses 39-2 of the second lens plate 37-2 form an image of the intermediate image 52 on the image plane 43. Accordingly, a sum of the distance LI1 and the distance LO2 is equal to the distance LS between the first lens plate 37-1 and the second lens plate 37-2 (LI1+LO2=LS).

An operation of the printer 10 will be explained next. First, a printing operation of the printer 10 will be explained. When the printer 10 receives the print data from the external device, a control unit (not shown) of the printer 10 generates the image data in colors according to the print data.

Further, the control unit controls the power source to apply a voltage, and controls the motor to rotate. Accordingly, the photosensitive drums 17K, 17Y, 17M, and 17C of the printing mechanism 13K, 13Y, 13M, and 13C start rotating. Further, upon receiving the voltage, the charging rollers 18K, 18Y, 18M, and 18C uniformly charge the surfaces of the photosensitive drums 17K, 17Y, 17M, and 17C. When the sheet 11 is supplied from the sheet supply cassette 22, the control unit controls the LED heads 15K, 15Y, 15M, and 15C to emit light upon passing the sheet 11 therethrough, thereby forming the static latent images on the photosensitive drums 17K, 17Y, 17M, and 17C.

In the next step, the developing devices 19K, 19Y, 19M, and 19C develop the static latent images, so that the toner images in black, yellow, magenta, and cyan are formed on the photosensitive drums 17K, 17Y, 17M, and 17C. Then, the transfer belt 12 starts moving and transports the sheet 11 between the photosensitive drum 17K and the transfer roller 16K.

When the sheet 11 is transported between the photosensitive drum 17K and the transfer roller 16K, a specific transfer voltage is applied to the transfer roller 16K. Accordingly, the toner image in black formed on the photosensitive drum 17K is transferred to the surface of the sheet 11. At this moment, the cleaning blade 20 scrapes off toner remaining on the photosensitive drum 17K.

In the next step, the sheet 11 is sequentially transported between each of the photosensitive drums 17Y, 17M, and 17C and the transfer rollers 16Y, 16M, and 16C. Accordingly, the toner images in yellow, magenta, and cyan are sequentially transferred to the sheet 11. After the toner images are transferred to the sheet 11, the transfer belt 12 transports the sheet 11 to the fixing device 27.

When the transfer belt 12 transports the sheet 11 to the fixing device 27, the fixing device 27 heats and presses the sheet 11, so that the toner images are melted and fixed to the sheet 11. Then, the transport roller 28 and the discharge roller 29 discharge the sheet 11 to the discharge portion 30. At last, in the printer 10, the control unit controls the power source to stop applying the voltage, and controls the motor to stop rotating, thereby competing the printing operation of the printer 10.

An operation of the LED head 15 will be explained next with reference to FIG. 5. In the printer 10, when the image data in colors are generated, the control unit generates a control signal to the LED heads 15, and sends the control signal to the corresponding driver IC 36.

When the driver IC 36 receives the control signal, the driver IC 36 controls the LED elements 33 to emit light in a specific amount according to the control signal. Accordingly, light from the LED elements 33 is incident on the lens array 31 and passes through the lens array 31, thereby forming an image on the photosensitive drum 17. As a result, the static latent image is formed on the photosensitive drum 17.

The operation of the LED head 15 will be explained in more detail next with reference to FIG. 1. In the lens array 31, when light from the LED element 33 is incident on the micro lenses 39-1 of the first lens plate 37-1, the micro lenses 39-1 form the intermediate image 52 at the position backward away from the micro lenses 39-1 by the distance LI1. Then, in the second lens plate 37-2, the micro lenses 39-2 facing the micro lenses 39-1 form the image of the intermediate image 52 on the image plane 43. Accordingly, the image of the LED elements 33 is formed on the image plane 43, i.e., the surface of the photosensitive drum 17.

Note that the micro lenses 39-1 form the intermediate image 52 as an inverted reduced image of the LED elements 33. Further, the micro lenses 39-2 form the image on the image plane 43 as an inverted enlarged image of the intermediate image 52.

As described above, in the embodiment, the first lens plate 37-1 and the second lens plate 37-2 are formed in an identical shape. When light from the LED elements 33 is incident on the micro lenses 39-1 of the first lens plate 37-1, the micro lenses 39-1 form the intermediate image 52 as the inverted reduced image of the LED elements 33 on the plane backward away from the micro lenses 39-1 by the distance LS/2. Then, in the second lens plate 37-2, the micro lenses 39-2 form the inverted enlarged image of the intermediate image 52 on the image plane 43. Accordingly, an upright same-size image of the LED elements 33 is formed on the surface of the photosensitive drum 17.

In the embodiment, a chief ray of light from the LED elements 33 is in parallel with each other between the micro lenses 39-1 and the micro lenses 39-2, i.e., telecentric. Further, as shown in FIGS. 1 and 8, between the first lens plate 37-1 and the second lens plate 37-2, RA is a maximum value of a distance between the optical axis of the micro lens 39 and an inner wall of the opening portion 40a of the light blocking member 38. The light blocking member 38 blocks a ray not contributing in forming an image among rays from the LED elements 33.

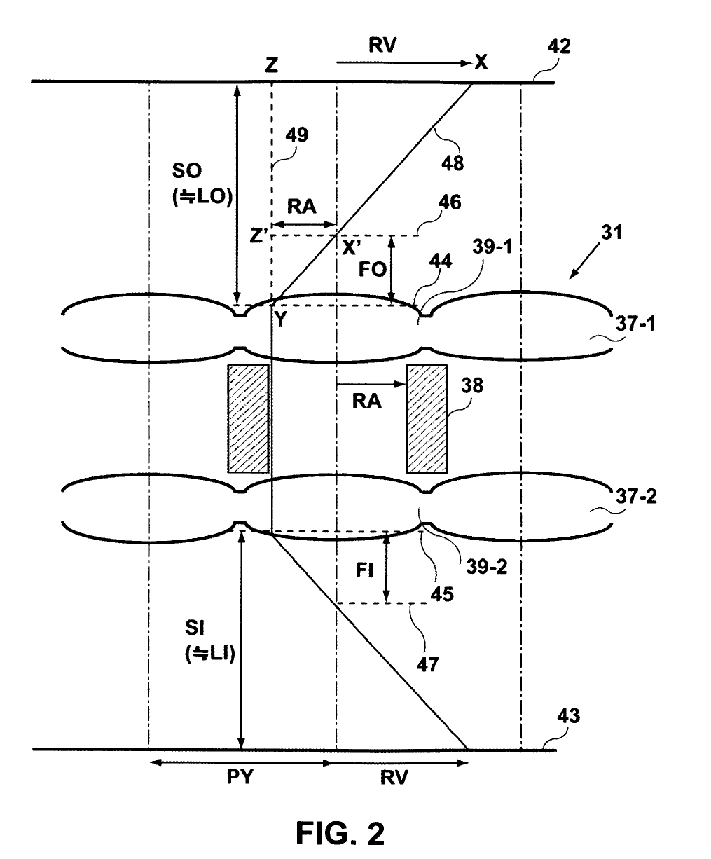

An optical property of the micro lenses 39 of the lens plates 37 will be explained next with reference to FIG. 2. FIG. 2 is a schematic view No. 2 showing the configuration of the LED head 15 according to the first embodiment of the present invention. Similar to FIG. 1, FIG. 2 is a sectional view of the LED head 15 taken along the line 1-1 in FIG. 5 with the plane passing through the optical axes of the micro lenses 39.

As shown in FIG. 2, the micro lens 39-1 of the first lens plate 37-1 has a first principal plane 44 on a side of the object plane 42, and the first principal plane 44 is represented with a hidden line on the micro lens 39-1. Further, the micro lens 39-2 of the second lens plate 37-2 has a second principal plane 45 on a side of the image plane 43, and the second principal plane 45 is represented with a hidden line on the micro lens 39-2. Further, the micro lens 39-1 has a first focal plane 46 as a forward focal plane, and the micro lens 39-2 has a second focal plane 47 as a backward focal plane.

In the first lens plate 37-1, the first principal plane 44 of the micro lens 39-1 is away from the object plane 42 by a distance SO. In this case, a difference between the distance LO between the first lens plate 37-1 and the object plane 42 (refer to FIG. 1) and the distance SO between the first principal plane 44 and the object plane 42 is inversely proportional to a curvature radius of a curved surface of the micro lens 39-1 facing the object plane 42.

Similarly, in the second lens plate 37-2, the second principal plane 45 of the micro lens 39-2 is away from the image plane 43 by a distance SI. A difference between the distance LI between the second lens plate 37-2 and the image plane 43 (refer to FIG. 1) and the distance SI between the second principal plane 45 and the image plane 43 is inversely proportional to a curvature radius of a curved surface of the micro lens 39-2 facing the image plane 43. In the lens array 20, the first

In the lens array 31, the micro lens 39-1 and the micro lens 39-2 have a large curvature radius, and the difference between the distance SO and the distance LO and the difference between the distance SI and the distance LI are negligible. Accordingly, the distance SO is substantially equal to the distance LO(SO≈LO), and the distance SI is substantially equal to the distance LI(SI≈LI).

Further, as described above, the chief rays of light from the object plane 42 are in parallel with each other between the micro lenses 39-1 of the first lens plate 27-1 and the micro lenses 39-2 of the second lens plate 27-2.

As shown in FIG. 2, among rays from the LED elements 33 arranged on the image plane 43 to the micro lens 39-1, a ray 48 will be explained next. The ray 48 passes through near the inner wall of the light blocking member 38, and crosses with the first focal plane 46 at a crossing point X′ situated on the optical axis of the micro lens 39-1. When the LED element 33 corresponding to the ray 48 is situated at a position X, a distance RV (refer to FIG. 2) from the crossing point between the optical axis of the micro lens 39-1 and the object plane 42 to the position X of the LED element 33 corresponds to a field of view radius of the micro lens 39-1.

As shown in FIG. 2, the ray 48 is incident on the first principal plane 44 at an incident position Y, and a perpendicular line 49 from the incident position Y to the object plane 42 crosses with the object plane 42 at a crossing point Z. Further, the ray 48 is incident on the first focal plane 46 at an incident position X′, and the perpendicular line 49 crosses with the first focal plane 46 at a crossing point Z′. At this moment, a rectangle XYZ formed of the ray 48, the perpendicular line 49, and the object plane 42 is homothetic to a triangle X′Y′Z′ formed of the ray 48, the perpendicular line 49, and the first focal plane 46. From the homothetic relationship between the triangle XYZ and the triangle X′Y′Z′, an equation (2) is obtained as follows:

$$RV = RA \frac{LO - FO}{FO} \qquad ( 2 )$$

where FO is the focal length of the micro lens 39-1, and corresponds to the distance from the first principal plane 44 of the micro lens 39-1 to the first focal plane 46.

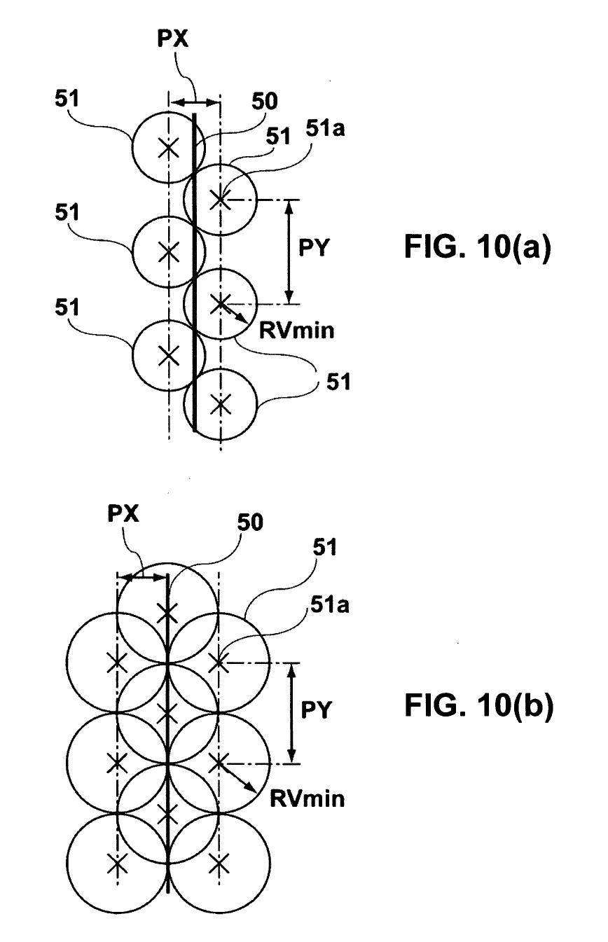

A relationship between the field of view radius RV of each of the micro lenses 39 of the lens plate 37 and an operational condition of the lens array 31 will be explained next with reference to FIGS. 10(a) and 10(b). FIGS. 10(a) and 10(b) are schematic views showing the micro lenses 39 of the lens array 31 according to the first embodiment of the present invention.

FIG. 10(a) shows a minimum value RVmin of the field of view radius RV as the operational condition of the lens array 31. More specifically, as shown in FIG. 10(a), an LED array 50 as a light emitting portion array is formed of the LED elements 33, and each of the micro lenses 39 of the lens plate 37 has a field of view 51. The field of view 51 has a radius RVmin and a center at a crossing point of the optical axis of each of the micro lenses 39 and the object plane 42.

As shown in FIG. 10(a), each of the LED elements 33 of the LED array 50 is included in one of the field of views 51 of the micro lenses 39. Accordingly, when the field of view radius RV of each of the micro lenses 39 of the lens array 31 satisfies the following equation (3), the lens array 31 can form an image of each of the LED elements 33 of the LED array 50:

RV≧RVₘᵢₙ (3)

The field of view radius RVmin shown in FIG. 10(a) can be expressed as follows:

$$RV = \sqrt{{( \frac{PX}{2} )}^{2} + {( \frac{PY}{4} )}^{2}} \qquad ( 4 )$$

where PX is an arrangement interval between the micro lenses 39 of the lens plate 37, and PY is an arrangement interval between the micro lenses 39 of the lens plate 37 in a longitudinal direction of the lens plate 37.

From the equations (2), (3), and (4), the following equation (5) is obtained as the operational condition of the lens array 31:

$$\sqrt{{( \frac{PX}{2} )}^{2} + {( \frac{PY}{4} )}^{2}} \leq RA \frac{LO - FO}{FO} \qquad ( 5 )$$

where FO is the focal length of the micro lens 39-1 of the first lens plate 37-1, LO is the distance between the lens array 31 and the object plane 42, and RA is an opening radius of the opening portion 40a of the light blocking member 38.

In the embodiment, when the micro lenses 39 are arranged in more than two rows in the lens plate 37 of the lens array 31, the equation (5) functions as the operational condition of the lens array 31.

FIG. 10(b) shows a relationship between the LED array 50 and the field of view 51 of each of the micro lenses 39 when the micro lenses 39 are arranged in three rows with an arrangement interval PX in the lens plate 37.

In this case, the arrangement interval PX of the micro lenses 39 in the lens plate 37 is not related to the operational condition of the lens array 31. Accordingly, the condition that each of the LED elements 33 of the LED array 50 is included in one of the field of views 51 of the micro lenses 39 corresponds to a case that PX is equal to zero (PX=0) in the equation (5). When the micro lenses 39 are arranged in more than three rows, or are arranged linearly in one row, the condition corresponds to the case.

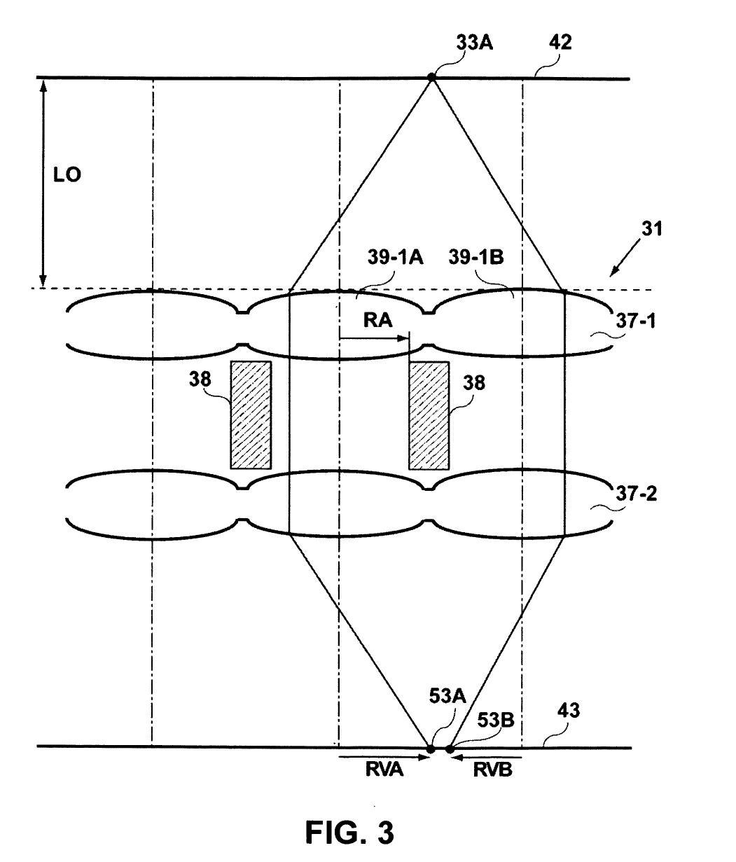

A condition for the LED head 15 as the exposure device to have a sufficient resolution will be explained with reference to FIG. 3. FIG. 3 is a schematic view No. 3 showing the configuration of the LED head 15 according to the first embodiment of the present invention. Similar to FIGS. 1 and 2, FIG. 3 is a sectional view of the LED head 15 taken along the line 1-1 in FIG. 5 with the plane passing through the optical axes of the micro lenses 39.

As shown in FIG. 3, in the first lens plate 37-1 of the lens array 31, two adjacent micro lenses 39-1 are designated as a micro lens 39-1A and a micro lens 39-1B. Among the LED elements 33, one of the LED elements 33 away from the micro lens 39-1A and the micro lens 39-1B by an equal distance is designated as an LED element 33A.

In this case, when the field of views 51 (refer to FIG. 10) of the micro lens 39-1A and the micro lens 39-1B are overlapped on the object plane 42, light from the LED element 33A within an overlapped area is incident on the micro lens 39-1A and the micro lens 39-1B, respectively. Accordingly, an image of the LED element 33A through the micro lens 39-1A and an image of the LED element 33A through the micro lens 39-1B are formed on the image plane 43, respectively.

In the lens plates 37 of the lens array 31, it is assumed that the micro lenses 39 have an exactly identical optical property. That is, the micro lenses 39 are formed to have an identical thickness, a curve shape, and the likes, and further the micro lenses 39 have an identical focal length f. In this case, even when the field of views 51 of the micro lenses 39 are overlapped on the object plane 42, and a plurality of images of one single LED element 33 is formed, image forming positions on the image plane 43 are matched. In other words, a plurality of images of one single LED element 33 is overlapped on the image plane 43.

In an actual case, it is very difficult to form the lens plate 37, in which the micro lenses 39 have an exactly identical optical property. Accordingly, a plurality of images of one single LED element 33 is formed on the image plane 43 at various image forming positions due to a variance in an optical property of the micro lenses 39.

In order to maintain a sufficient resolution of the LED head 15 in the case described above, it is necessary to reduce a shift of the image forming positions less than a half of the arrangement pitch PD of the LED elements 33 in the LED array 50. When the condition is satisfied, it is possible to overlap a plurality of images of one single LED element 33 on the image plane 43 without shifting.

As shown in FIG. 3, the image of the LED element 33A through the micro lens 39-1A is formed on the image plane 43 at an image forming position 53A away from the optical axis of the micro lens 39-1A by a distance RVA. Similarly, the image of the LED element 33A through the micro lens 39-1B is formed on the image plane 43 at an image forming position 53B away from the optical axis of the micro lens 39-1B by a distance RVB. When the following equation (6) is satisfied, the images are overlapped:

$$\vert RVA - RVB \vert < \frac{PD}{2} \qquad ( 6 )$$

When the focal length FO of the micro lens 39-1A is designated as FOA (FO=FOA), and the focal length FO of the micro lens 39-1B is designated as FOB (FO=FOB) in the equation (2), the equation (6) is rewritten as follows:

$$\vert \frac{1}{FOA} - \frac{1}{FOB} \vert < \frac{PD}{2 LO \cdot RA} \qquad ( 7 )$$

When the focal length FO of the micro lenses 39 of the lens plate 37 has a minimum value FOA and a maximum value FOB, and the minimum value FOA and the maximum value FOB satisfy the equation (7), it is possible to obtain a sufficient resolution of the LED head 15 without accurately matching an optical property of each of the micro lenses 39.

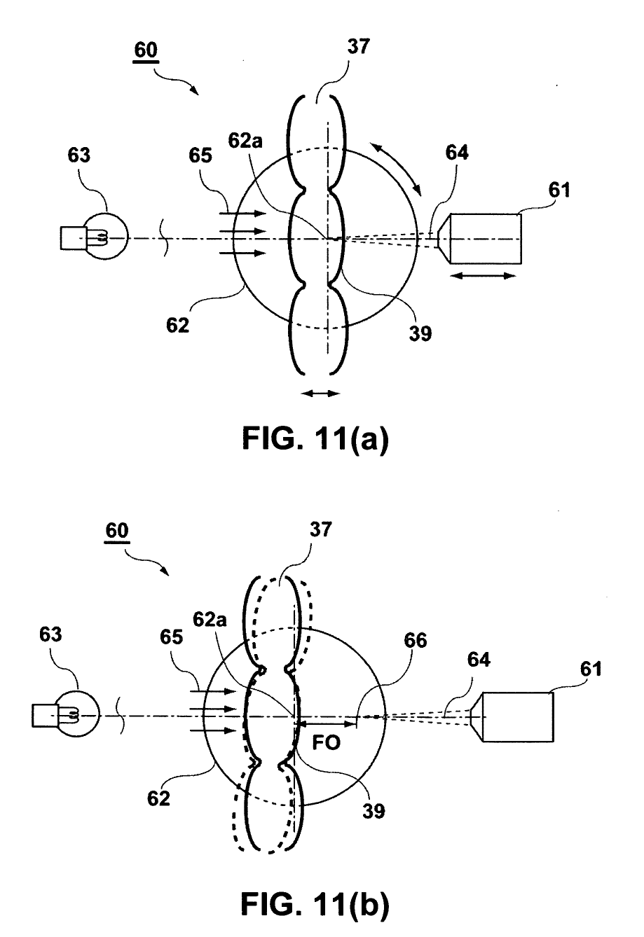

A method of measuring the focal length FO of the micro lenses 39 will be explained with reference to FIGS. 11(a) and 11(b). FIGS. 11(a) and 11(b) are schematic views showing a focal length measurement device 60.

In the embodiment, the focal length measurement device 60 measures the focal length FO of the micro lenses 39 of the lens plate 37 with a nodal slide method. As shown in FIG. 11, the focal length measurement device 60 includes a microscope 61, a rotational base 62, and a light source 63.

In the focal length measurement device 60, the microscope 61 is arranged to movable along an optical axis 64. The rotational base 62 places the lens plate 37 as a measurement object. The rotational base 62 has a center 62a situated on the optical axis 64 of the microscope 61, so that the rotational base 62 rotates around the center 62a by a small angle. The lens plate 37 is placed on the rotational base 62 to be movable along the optical axis 64 of the microscope 62. The light source 63 irradiates a ray 65 toward the lens plate 37 on the rotational base 62 along the optical axis 64.

A flow of the measurement of the focal length FO of the micro lenses 39 in the lens plate 37 with the focal length measurement device 60 will be explained next. First, an operator adjusts the microscope 61, so that an object plane of the microscope 61 is situated at the center 62a of the rotational base 62. Further, the lens plate 37 is placed on the rotational base 62, so that the optical axis of the micro lens 39 as the measurement object is matched with the optical axis 64 of the microscope 61.

In the next step, as shown in FIG. 11(b), the operator moves one or both of the microscope 61 and the lens plate 37 along the optical axis 64, so that the object plane of the microscope 61 moves away from the light source 64. At this moment, the ray 65 from the light source 64 is collected with the micro lens 39 as the measurement object, thereby forming a spot on the object plane of the microscope 61.

While moving the microscope 61 and the lens plate 37 along the optical axis 64, the operator tries to find a position where a radius of the spot or a spot radius formed with the micro lens 39 becomes minimum and the spot radius does not change when the rotational base 62 rotates by a small angle.

At the position where the spot radius becomes minimum and does not change when the rotational base 62 rotates by a small angle, a principal point of the micro lens 39 is matched to the center 62a of the rotational base 62. More specifically, the center 62a of the rotational base 62 is situated at a crossing point of the first principal plane of the micro lens 39 and the optical axis 64. Accordingly, a distance between the center 62a of the rotational base 62 and the object plane of the microscope 61 corresponds to the focal length FO of the micro lens 39.

When the micro lens 39 has an F number FN indicating a brightness of the micro lens 39, the F number is expressed with the following equation (8):

$$FN = \frac{FO}{2 RA} \qquad ( 8 )$$

where FO is the focal length of the micro lens 39, and RA is the opening diameter of the opening portion 40a of the light blocking member 38.

When the micro lens 39-1A has an F number FNA and the micro lens 39-1B has an F number FNB in FIG. 3, the equation (7) regarding the focal lengths FOA and FOB can be rewritten to the following equation (9) based on the equation (8):

$$\vert \frac{1}{FNA} - \frac{1}{FNB} \vert < \frac{PD}{LO} \qquad ( 9 )$$

Accordingly, even if the F numbers of the micro lenses 39 in the lens plate 37 are not matched, when the minimum value FNA and the maximum value FNB of the F number satisfy the equation (9), it is possible to obtain a sufficient resolution of the LED head 15. The F numbers of the micro lenses 39 may vary due to an error in the opening radius RA of the light blocking member 38, in addition to a variance in an optical property of the micro lenses 39 described above.

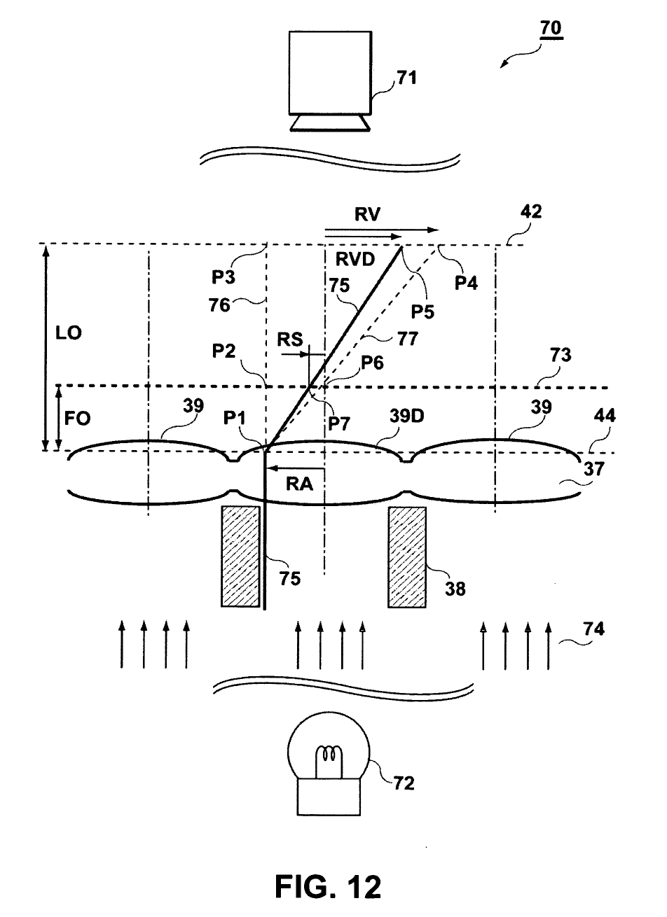

A method of evaluating an optical property of the micro lenses 39 in the lens plate 37 will be explained next. FIG. 12 is a schematic view showing an optical property evaluation system 70. Similar to FIGS. 1 to 3, FIG. 12 is a sectional view taken along the plane passing through the optical axes of the micro lenses 39 of the lens plate 37. A left-to-right direction in FIG. 12 corresponds to the longitudinal direction of the lens plate 37.

As shown in FIG. 12, the optical property evaluation system 70 includes a CCD camera 71 and a lamp 72 for evaluating the optical property of the micro lenses 39 in the lens plate 37. In the optical property evaluation system 70, the object plane 42 of the lens plate 37 is situated at a position away from the lens plate 37 by a distance LO in the optical axis direction of the micro lenses 39. When one of the micro lenses 39 has a focal length FO, an evaluation plane 73 is situated at a position away from the first principal plane 44 of the lens plate 37 by the focal length FO in the optical axis direction. The evaluation plane 73 is an object plane of the CCD camera 71 as an image reading apparatus and an imaginary plane.

In the optical property evaluation system 70, the light blocking member 38 is disposed such that the opening portions 40a with the opening diameter RA correspond to the optical axes of the micro lenses 39, similar to the lens array 31 shown in FIG. 6. The lamp 72 is arranged as a lighting device such that parallel rays 74 are incident on the lens plate 37. The lamp 72 is formed of a light source capable of irradiating light having a wavelength substantially the same as that of the LED elements 33 (refer to FIG. 5). Alternatively, a filter may be disposed along with the lamp 72 for passing through light having such a wavelength.

In the optical property evaluation system 70, the CCD camera 71 captures an image of a spot formed on the evaluation plane 73 with the lens plate 37. An analytical unit analyzes a brightness distribution of the spot on the evaluation plane 73 according to the image taken with the CCD camera 71, thereby evaluating the optical property of the micro lenses 39.

An operation of the optical property evaluation system 70 for evaluating the optical property of the lens plate 37 will be explained next. In the operation, among the micro lenses 39 of the lens plate 37, it is supposed that a micro lens 39D shown in FIG. 12 is a subject to the evaluation.

In the optical property evaluation system 70, when the lamp 72 is turned on, the parallel rays 74 are incident on the micro lenses 39 of the lens plate 37. At this moment, among the parallel rays 74 incident on the micro lens 39D, i.e., the subject to the evaluation, a ray 75 furthest from an optical axis of the micro lens 39D passes through a position P7 on the evaluation plane 73 from a position P1 on the first principal plane 44, and is incident on a position P5 on the object plane 42 as shown in FIG. 12. The optical axis of the micro lens 39D crosses with the evaluation plane 73 at a crossing point P6 away from the position P7 on the evaluation plane 73 by a distance RS.

When light of the lamp 73 is incident on the micro lens 39D, a spot homothetic to the shape of the opening portion 40a of the light blocking member 38 is formed on the evaluation plane 73. The spot has a circular shape with a center position P6 and a radius or a spot radius RS.

In the optical property evaluation system 70, a perpendicular line 76 from the incident position P1 of the ray 75 on the first principal plane 44 to the object plane 42 crosses with the evaluation plane 73 at a crossing point P2. Further, the perpendicular line 76 crosses with the object plane 42 at a crossing point P3. In this case, a triangle P1-P2-P7 formed of the ray 75, the perpendicular line 76, and the object plane 42 is homothetic to a triangle P1-P2-P7 formed of the ray 75, the perpendicular line 76, and the evaluation plane 73. From the relationship, the following equation (10) is obtained:

$$RVD = \frac{LO}{FO} ( RA - RS ) - RA \qquad ( 10 )$$

where RVD is a distance between the incident position P5 of the ray 75 on the object plane 42 and the optical axis of the micro lens 39.

In the optical property evaluation system 70, a straight line 77 including the position P1 and the position P6 crosses with the object plane 42 at a crossing point P4. In this case, a distance between the position P4 on the object plane 42 and the optical axis of the micro lens 39 is equal to the field of view radius RV (refer to FIG. 2) of the micro lens 39D on the object plane 42. Accordingly, a triangle P1-P3-P4 formed of the straight line 77, the perpendicular line 76, and the object plane 42 is homothetic to a triangle P1-P2-P6 formed of the straight line 77, the perpendicular line 76, and the evaluation plane 73. From the relationship, the equation (2) is obtained as described above with reference to FIG. 2.

In the equation (6), it is supposed that the distance RVA is equal to the field of view radius RV (RVA=RV), and the distance RAB is equal to the distance RVD (RVB=RVD). When the relationships are substituted into the equations (10) and (2), the following equation (11) is obtained:

$$RS < \frac{PD \cdot FO}{2 LO} \qquad ( 11 )$$

When the micro lenses 39 of the lens plate 37 form the spots on the evaluation plane 73, and the spots have the spot radius RS satisfying the equation (11), it is determined that the lens array 31 formed of the lens plates 37 and the LED head 15 are capable of forming dots with a sufficient resolution.

In the optical property evaluation system 70, the CDD camera capture 71 captures an image of a spot formed on the evaluation plane 73, and the analytical unit analyzes a brightness distribution of the spot and measures the spot radius RS, thereby determining whether the spot radius RS satisfies the equation (11).

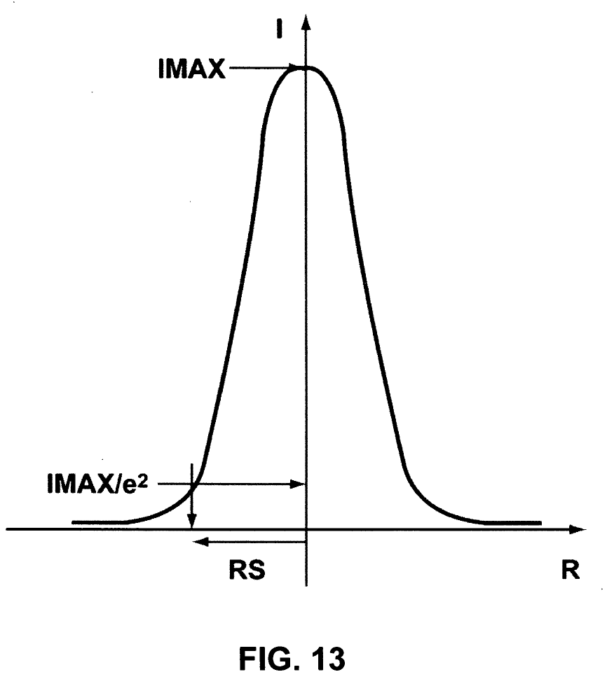

FIG. 13 is a graph showing the brightness distribution of the spot formed on the evaluation plane 73. In FIG. 13, the horizontal axis represents a position R on the evaluation plane 73. The origin (R=0) corresponds to the crossing point P6 between the evaluation plane 73 and the optical axis of the micro lens 39D. The vertical axis represents a brightness value I.

In the optical property evaluation system 70, when the lamp 72 is turned on, the spot with the center at the position P6 is formed on the evaluation plane 73 as shown in FIG. 13. The spot has a maximum brightness value IMAX at the position P6. The analytical unit of the optical property evaluation system 70 measures the maximum brightness value IMAX and determines the spot radius RS as a radius of an area where the brightness value I satisfies the following equation:

I≧IMAX/e²

where e is the base of natural logarithm.

Accordingly, the analytical unit determines whether the spot radius RS satisfies the equation (11), thereby evaluating the optical property of the micro lens 39D. When all of the micro lenses 39 of the lens plate 37 form the spots with the spot radii RS satisfying the equation (11), the optical property evaluation system 70 determines that the lens array 31 formed of the lens plate 37 and the LED head 15 have a sufficient resolution.

In the brightness distribution shown in FIG. 13, the spot with the center at the position P6 has a brightness distribution in an area where an absolute value of the position R is smaller than the spot radius RS (IRI<RS). The micro lens 39D forms the spot on the evaluation plane 37 having the brightness distribution in the area due to light diffraction.

In order to evaluate the LED head 15 satisfying the equations described above, an MTF (Modulation Transfer Function) indicating a resolution of an exposed image is measured. The MTF is a function indicating a contrast of a light amount of an image formed on the image plane 43 of the LED elements 33 in the LED head 15 or the exposure device. When the MTF shows a larger value, the image has a larger contrast, thereby indicating that the exposure device has a higher resolution.

A value (%) of the MTF is represented with the following equation (12):

<MTF≧(Eₘₐₓ−Eₘᵢₙ)/(Eₘₐₓ+Eₘᵢₙ)×100 (12)

where Eₘₐₓ is a maximum value of the light amount of the image formed on the image plane 43, and Eₘᵢₙ is a minimum value of a difference in the light amounts of two adjacent images.

In the evaluation, a microscope digital camera captures a picture of an exposed image at a position away from the image plane 43 of the lens array 31 of the LED head 15, i.e., the surface of the photosensitive drum 17, by a distance L1 (mm). Then, the light amount of the image of the LED element 33 is analyzed to measure the value of the MTF.

In the evaluation, the LED elements 33 are arranged with the arrange pitch PD of 0.0423 mm, and the LED head 15 has a resolution of 600 dpi. The lens array 31 is mounted on the LED head 15, and alternate one of the LED elements 33 emits light to measure the value of the MTF. As a result, the value of the MTF is greater than 80%, thereby indicating that the LED head 15 has a sufficient resolution.

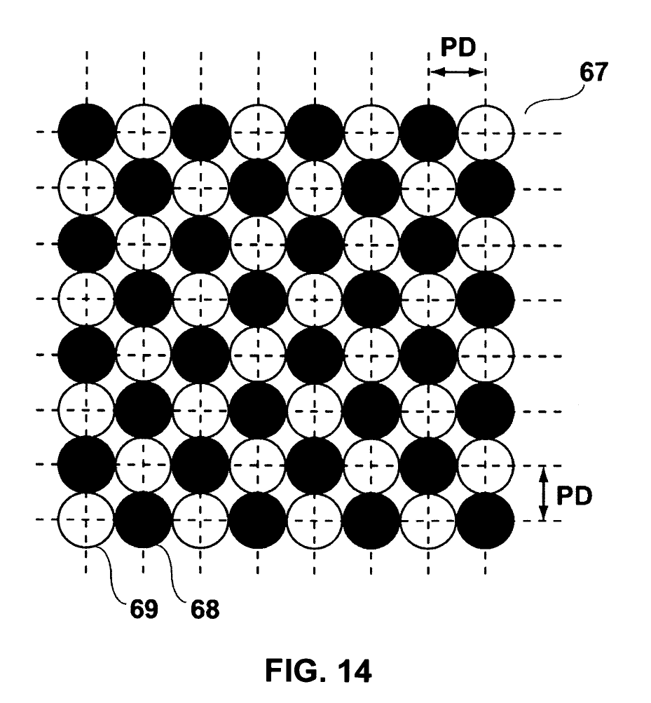

An evaluation of the printer 10 (refer to FIG. 4) with the LED head 15 will be explained next. In the evaluation, the printer 10 prints an evaluation pattern 67 shown in FIG. 14. FIG. 14 is a schematic view showing the evaluation pattern 67.

As shown in FIG. 14, the evaluation pattern 67 includes print image pixels 68 and non-print image pixels 68 alternately arranged over an entire printable area of the sheet 11. According to a result of the printing operation, the printer 10 is evaluated in terms of image quality, and it is found that the printer 10 can obtain the image with high quality without a streak or an uneven spot.

As described above, in the embodiment, even if the optical properties of the micro lenses 39 in the lens plate 37 are not matched, when any pair of the micro lenses 39 has the focal lengths FOA and FOB satisfying the equation (7), and the minimum value FNA and the maximum value FNB satisfying the equation (9), the micro lenses 39 form the spot with the spot radius RS satisfying the equation (11). Accordingly, it is possible to form a dot with a sufficient resolution. As a result, it is possible to produce the micro lenses 39 and the lens plates 37 with lower dimensional requirement, thereby improving productivity of the lens array 31. When the printer 10 is provided with the LED head 15, it is possible to obtain an image with high quality without a streak or an uneven spot.

In the embodiment, each of the micro lenses 39 of the lens array 31 has the rotationally symmetrical high order aspheric surface, and is not limited thereto. The micro lenses 39 may have a curved surface such as a spherical surface, an anamorphic aspheric surface, a parabolic surface, an oval surface, a hyperbolic surface, a Korenich surface, and the likes.

In the embodiment, the lens plate 37 is molded with a metal mold, and may be formed with a resin mold, or through machining. Further, the lens plate 37 is formed of a resin, and may be formed of glass.

In the embodiment, the focal length measurement device 60 (refer to FIG. 11) measures the focal length of the micro lenses 39 with the nodal slide method, and other measurement device may be used. Further, a measurement device may be used for measuring other numbers capable of being converted to the focal length and the F number.

In the embodiment, the optical property evaluation system 70 is used for evaluating the optical property of the micro lens 39 of the lens plate 37 one by one, and is capable of evaluating a plurality of the micro lenses 39 at the same time. In this case, the lamp 72 is arranged such that the parallel rays are incident on the micro lenses 39 at the same time, so that the CCD camera 71 takes a plurality of spots on the evaluation plane 73 at the same time. Accordingly, the optical property evaluation system 70 can efficiently evaluate the optical property of the micro lenses 39 of the lens plate 37.

In the embodiment, a plurality of the LED elements 33 as the light emitting portions is arranged to form the LED array 50, and the LED head 15 as the exposure device provided with the LED array 50 is disposed in the printer 10, and the present invention is not limited thereto. Alternatively, the LED array 50 may be formed of an organic EL (Electro Luminescence), a semiconductor laser. Further, instead of the LED head 15, an exposure device may be formed of a light emitting portion such as a fluorescent lamp and a halogen lamp and a shutter formed of a liquid crystal element.

### Second Embodiment

A second embodiment of the present invention will be explained next. In the first embodiment, when the equations (7) and (9) are satisfied, it is possible to alleviate the dimensional accuracy. When it is necessary to provide the LED head 15 with a sufficient resolution, it is necessary to precisely arrange the lens array 31 between the LED array 50 and the photosensitive drum 17 with a constant distance therebetween, thereby requiring accuracy in an installation position.

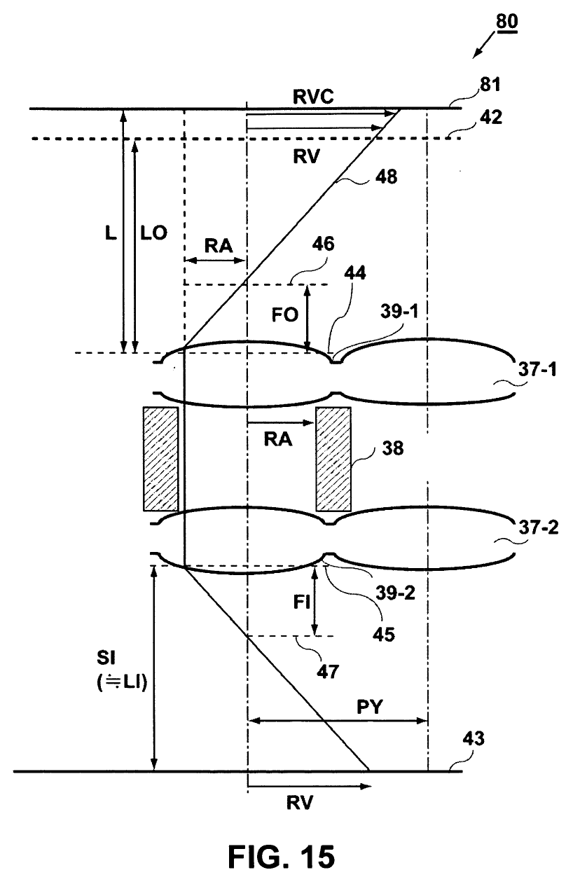

In the second embodiment, it is configured such that it is possible to alleviate the installation position accuracy. FIG. 15 is a schematic view showing a configuration of an LED head 80 according to the second embodiment of the present invention. Similar to FIG. 1, FIG. 15 is a sectional view of the LED head 80 taken along the-plane passing through the optical axes of the micro lenses 39. A left-to-right direction in FIG. 15 corresponds to the longitudinal direction of the lens plate 37. Components in the second embodiment similar to those in the first embodiment are designated with the same reference numerals, and explanations thereof are omitted.

In the embodiment, the lens array 31 is disposed between an object plane 81 and the image plane 43. An arrangement plane of an LED array in which the LED elements 33 are arranged corresponds to the object plane 81. The surface of the photosensitive drum 17 corresponds to the image plane 43.

As shown in FIG. 15, in the first embodiment, the LED array 50 of the LED head 15 is arranged on the object plane 42 indicated with a hidden line. The object plane 42 is situated at a position away from the first lens plate 37-1 by the distance LO. In the second embodiment, the LED array of the LED head 80 is shifted along the optical axis direction of the micro lenses 39, so that the object plane 81 is situated at a position away from the first lens plate 37-1 by a distance L.

In this case, the field of view radius RV of the micro lens 39 on the object plane 42 before the shift is given by the following equation (13):

$$RV = RA \frac{LO - FO}{FO} \qquad ( 13 )$$

where FO is the focal length of the micro lens 39, and RA is the opening diameter of the light blocking member 38.

When the micro lens 39 has a field of view radius RVC on the object plane 81, the field of view radius RVC is given by the following equation (14):

$$RVC = RA \frac{L - FO}{FO} \qquad ( 14 )$$

In the equation (6) in the first embodiment, it is supposed that the distance RVA is equal to the field of view radius RV (RVA=RV), and the distance RVB is equal to the field of view radius RVC (RVB=RVC). In this case, when the equations (13) and (14) are substituted into the equation (6), the following equation (15) is obtained:

$$\vert L - LO \vert < \frac{PD}{2} \cdot \frac{FO}{RA} \qquad ( 15 )$$

Accordingly, when it is arranged such that the distance L between the object plane 81 and the lens array 31 satisfies the equation (15), it is possible to provide the LED head 80 with a sufficient resolution.

When the micro lenses 39 are arranged in parallel along the optical axis direction with a parallel degree DL, the parallel degree is given by the following equation (16):

DL=\L−LO\ (16)

Accordingly, when it is arranged so that the following equation (17) is satisfied, it is possible to provide the LED head 80 with a sufficient resolution.:

$$DL < \frac{PD}{2} \cdot \frac{FO}{RA} \qquad ( 17 )$$

Using the F number FN of the micro lenses 39, the equation (17) can be rewritten in the following equation (18):

DL<PD·FN (18)

Accordingly, when it is arranged so that the following equation (18) is satisfied, it is possible to provide the LED head 80 with a sufficient resolution.

As described above, in the embodiment, it is configured such that it is possible to alleviate the installation position accuracy of the lens array 31 and the LED array, thereby further improving productivity.

### Third Embodiment

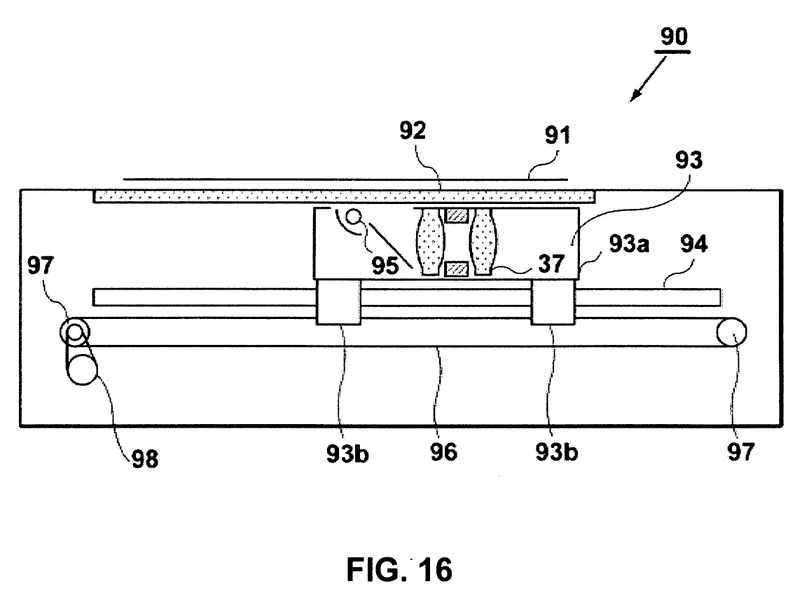

A third embodiment of the present invention will be explained next. FIG. 16 is a schematic view showing a configuration of a scanner 90 according to the third embodiment of the present invention. The scanner 90 functions as a reading apparatus for reading an image on an original 91 and creating electrical data. Components in the third embodiment similar to those in the first and second embodiments are designated with the same reference numerals, and explanations thereof are omitted.

As shown in FIG. 16, the scanner 90 includes an original table 92 for placing the original 91. The original table 92 is formed of a material transparent relative to visible light. The original 90 is placed on the original table 92 such that a reading surface thereof as a subject to be read faces downwardly.

In the embodiment, the scanner 90 further includes a reading head 93 with the lens array 31 mounted thereon. The reading head 93 is arranged to be movable on a rail 94 in a state that two leg portions 93b thereof engage the rail 94. As shown in FIG. 16, the reading head 93 is stationary at a left side of the rail 94 when the scanner 90 is not operated.

In the embodiment, a lamp 93 as a light unit is disposed in a frame 93a of the reading head 93 for irradiating the original 91 on the original table 92. The canner 90 further includes a drive belt 96 connected to the leg portions 93b of the reading head 93, and a plurality of pulleys 97 extends the drive belt 96. As shown in FIG. 16, one of the pulleys 97 is connected to a motor 98. The motor 98 drives the drive belt 96 to rotate for moving the reading head 93 and the lamp 95 in parallel to the reading surface of the original 91.

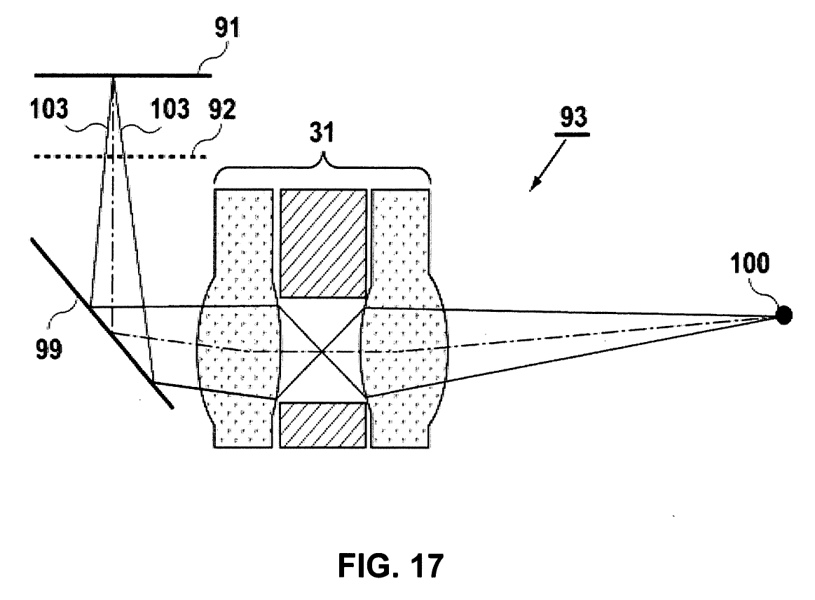

A configuration of the reading head 93 will be explained in more detail with reference to FIG. 17. FIG. 17 is a schematic view showing the reading head 93 of the scanner 90 according to the third embodiment of the present invention.

As shown in FIG. 17, the reading head 93 includes a mirror 99, the lens array 31, and a line sensor 100 disposed inside the frame 93a (refer to FIG. 16). The mirror 99 is arranged below the original table 92, so that the mirror 99 reflects a light path of reflection light 103 from the original 91 and irradiates the reflection light 103 to the lens array 31.

In the embodiment, the reflection light 103 is incident on the lens array 31 through the mirror 99, and passes through the lens array 31, thereby forming an image of the original 91. The lens array 31 has a configuration similar to that in the first and second embodiments. The line sensor 100 is formed of a plurality of light receiving elements arranged linearly with an arrangement pitch PR for converting the image of the original 91 formed with the lens array 31 to an electrical signal. In the scanner 90, the reading head 93 has a resolution of 600 dpi. More specifically, 600 of the light receiving elements are arranged in the line sensor 100 per one inch (=about 25.4 mm) with the arrangement interval of 0.0423 mm.

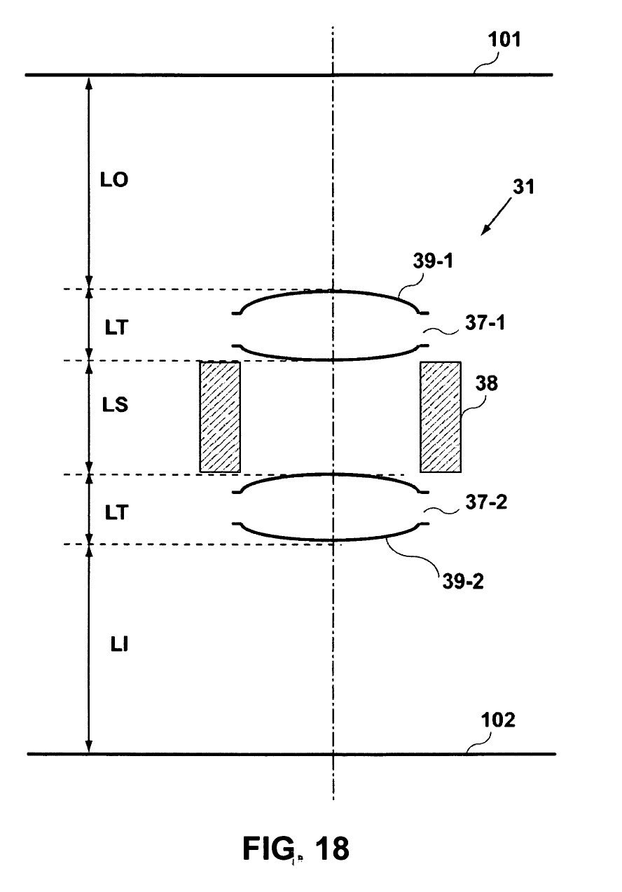

FIG. 18 is a schematic view showing an optical system of the scanner 90 according to the third embodiment of the present invention. In the scanner 90, the lens array 31 passes through reflection light from the original 90, and forms an image on the line sensor 100. Accordingly, an object plane 101 of the lens array 31 corresponds to the reading surface of the original 91, and an image plane 102 corresponds to an arrangement surface of the line sensor 100.

An operation of the scanner 90 will be explained next. When the scanner 90 is not operated, the reading head 93 is stationary at a left side of the rail 94 as shown in FIG. 16. In this state, the original 91 as the object to be read is placed on the original table 921, and a reading start request is input through an input unit (not shown).

When the reading start request is input, a control unit (not shown) controls the lamp 95 to turn on and irradiate the original 91. Light from the lamp 95 reflects at a reading start line, i.e., a left edge of the original 91, so that the reading head 93 receives the reflection light 103 (refer to FIG. 17). The motor 98 starts rotating, so that the drive belt 96 rotates clockwise at a specific speed (refer to FIG. 16). Accordingly, the reading head 93 and the lamp 95 move in the right direction along the rail 94, so that the reading head 93 receives the reflection light reflected from an entire surface of the original 91.

As shown in FIG. 17, after the reflection light 103 reflected from the original 91 passes through the original table 92, the mirror 99 bends the optical path thereof, thereby being incident on the lens array 31, so that the lens array 31 forms the image of the original on the line sensor 100. The line sensor 100 converts the image to the electrical signal, and outputs the electrical data of the original image.

As described above, the scanner 90 provided with the lens array 31 reads the image on the original, thereby creating the electrical data.

In order to evaluate the scanner 90, the scanner 90 performs a reading operation of an original with the evaluation pattern 67 shown in FIG. 14 printed an entire printable area thereof. As described above, the evaluation pattern 67 includes the print image pixels 68 and the non-print image pixels 68 alternately at all dots with the resolution of 600 dpi with the interval PD of 0.0423 mm. As a result of the evaluation, the scanner 90 is capable of creating the image data identical to the evaluation pattern 67 shown in FIG. 14.

As described above, in the embodiment, even if the optical properties of the micro lenses 39 in the lens plate 37 are not matched, when the focal lengths and the F numbers satisfy the specific conditions, the lens array 31 formed of the micro lenses 39 can form an image with a sufficient contrast, a deep focal length, and sufficient brightness. When the scanner 90 is provided with the lens array 31, it is possible to obtain image data with high quality and reproducibility of an original image.

In the embodiments, the scanner is explained as an example of the reading apparatus for converting the original image to the electrical signal, and the present invention is not limited thereto. The present invention is applicable to a sensor or a switch for converting an optical signal to an electrical signal, or an input/output device, a biometric authentication device, a communication device, a dimension measurement device using the sensor or the switch.

The disclosure of Japanese Patent Application No. 2008-168904, filed on Jun. 27, 2008, is incorporated in the application by reference.

While the invention has been explained with reference to the specific embodiments of the invention, the explanation is illustrative and the invention is limited only by the appended claims.

What is claimed is:

1. An exposure device comprising:
a light emitting portion array formed of a plurality of light emitting portions, said light emitting portions being arranged substantially linearly with a specific interval PD in between; and
a lens array including a plurality of lens assembly members and at least one light blocking member, said lens assembly members being arranged substantially in parallel to the light emitting portion array, said light blocking member being arranged between the lens assembly member, each of said lens assembly members including a plurality of lenses arranged in a direction perpendicular to optical axes thereof so that the optical axes of the lenses are aligned with those of lenses of an adjacent lens assembly member arranged to face the lenses, said light blocking member including a plurality of apertures arranged such that an optical axis of a pair of the lenses of two adjacent lens assembly members facing each other passes through each of the apertures, said light emitting portion array and said lens array being arranged so that when light in parallel to the optical axis of one of the lenses is incident to the one of the lenses from a direction of the light blocking member, the one of the lenses forms a spot having a radius RS satisfying the following relationship:
$$RS < \frac{PD \cdot FO}{2 LO}$$
where FO is a focal length of the one of the lenses, LO is a distance between the one of the lenses and the light emitting portion array, and FO is a distance between the one of the lenses and a plane where the spot is formed on a side of the light emitting portions.

2. The exposure device according to claim 1, wherein said lenses include at least two lenses having F numbers FNA and FNB satisfying the following relationship:
$$\vert \frac{1}{FNA} - \frac{1}{FNB} \vert < \frac{PD}{LO}$$

3. The exposure device according to claim 1, wherein said lenses include at least two lenses having focal lengths FOA and FOB satisfying the following relationship:
$$\vert \frac{1}{FOA} - \frac{1}{FOB} \vert < \frac{PD}{2 LO \cdot RA}$$
where RA is a maximum value of a distance between the optical axis of the two lenses and an inner wall of the aperture corresponding to the two lenses.

4. The exposure device according to claim 1, wherein said lenses are arranged so that optical axes thereof extend in parallel each other with a parallel degree DL satisfying the following equation:
DL<PD·FN
where FN is an F number of the lenses.

5. The exposure device according to claim 1, wherein said lenses are arranged so that optical axes thereof extend in parallel each other with a parallel degree DL satisfying the following equation:
$$DL < \frac{PD}{2} \cdot \frac{FO}{RA}$$
where FO is a focal length of the lenses, and RA is a distance between the optical axis of one of the lenses and an inner wall of the aperture corresponding to the one of the lenses.

6. An image forming apparatus comprising the exposure device according to claim 1.

7. An LED (Light Emitting Diode) head comprising:
an LED array formed of a plurality of LED elements, said LED elements being arranged substantially linearly with a specific interval PD in between; and
a lens array including a plurality of lens assembly members and at least one light blocking member, said lens assembly members being arranged substantially in parallel to the LED array, said light blocking member being arranged between the lens assembly member, each of said lens assembly members including a plurality of lenses arranged in a direction perpendicular to optical axes thereof so that the optical axes of the lenses are aligned with those of lenses of an adjacent lens assembly member arranged to face the lenses, said light blocking member including a plurality of apertures arranged such that an optical axis of a pair of the lenses of two adjacent lens assembly members facing each other passes through each of the apertures, said LED array and said lens array being arranged so that when light in parallel to the optical axis of one of the lenses is incident to the one of the lenses from a direction of the light blocking member, the one of the lenses forms a spot having a radius RS satisfying the following relationship:
$$RS < \frac{PD \cdot FO}{2 LO}$$
where FO is a focal length of the one of the lenses, LO is a distance between the one of the lenses and the LED array, and FO is a distance between the one of the lenses and a plane where the spot is formed on a side of the LED elements.

8. The LED head according to claim 7, wherein said lenses include at least two lenses having F numbers FNA and FNB satisfying the following relationship:
$$\vert \frac{1}{FNA} - \frac{1}{FNB} \vert < \frac{PD}{LO}$$

9. The LED head according to claim 7, wherein said lenses include at least two lenses having focal lengths FOA and FOB satisfying the following relationship:
$$\vert \frac{1}{FOA} - \frac{1}{FOB} \vert < \frac{PD}{2 LO \cdot RA}$$
where RA is a maximum value of a distance between the optical axis of the two lenses and an inner wall of the aperture corresponding to the two lenses.

10. The LED head according to claim 7, wherein said lenses are arranged so that optical axes thereof extend in parallel each other with a parallel degree DL satisfying the following equation:
DL<PD·FN
where FN is an F number of the lenses.

11. The LED head according to claim 7, wherein said lenses are arranged so that optical axes thereof extend in parallel each other with a parallel degree DL satisfying the following equation:
$$DL < \frac{PD}{2} \cdot \frac{FO}{RA}$$
where FO is a focal length of the lenses, and RA is a distance between the optical axis of one of the lenses and an inner wall of the aperture corresponding to the one of the lenses.

12. An image forming apparatus comprising the LED head according to claim 7.

13. A reading apparatus comprising:
a line sensor formed of a plurality of light receiving elements, said light receiving elements being arranged substantially linearly with a specific interval PR in between; and
a lens array including a plurality of lens assembly members and at least one light blocking member, said lens assembly members being arranged substantially in parallel to the line sensor, said light blocking member being arranged between the lens assembly member, each of said lens assembly members including a plurality of lenses arranged in a direction perpendicular to optical axes thereof so that the optical axes of the lenses are aligned with those of lenses of an adjacent lens assembly member arranged to face the lenses, said light blocking member including a plurality of apertures arranged such that an optical axis of a pair of the lenses of two adjacent lens assembly members facing each other passes through each of the apertures, said line sensor and said lens array being arranged so that when light in parallel to the optical axis of one of the lenses is incident to the one of the lenses from a direction of the light blocking member, the one of the lenses forms a spot having a radius RS satisfying the following relationship:
$$RS < \frac{PR \cdot FO}{2 LO}$$
where FO is a focal length of the one of the lenses, LO is a distance between the one of the lenses and the line sensor, and FO is a distance between the one of the lenses and a plane where the spot is formed on a side of the light receiving elements.

14. The reading apparatus according to claim 13, wherein said lenses include at least two lenses having F numbers FNA and FNB satisfying the following relationship:
$$\vert \frac{1}{FNA} - \frac{1}{FNB} \vert < \frac{PR}{LO}$$

15. The reading apparatus according to claim 13, wherein said lenses include at least two lenses having focal lengths FOA and FOB satisfying the following relationship:
$$\vert \frac{1}{FOA} - \frac{1}{FOB} \vert < \frac{PR}{2 LO \cdot RA}$$
where RA is a maximum value of a distance between the optical axis of the two lenses and an inner wall of the aperture corresponding to the two lenses.

16. The reading apparatus according to claim 13, wherein said lenses are arranged so that optical axes thereof extend in parallel each other with a parallel degree DL satisfying the following equation:
DL<PR·FN
where FN is an F number of the lenses.

17. The reading apparatus according to claim 13, wherein said lenses are arranged so that optical axes thereof extend in parallel each other with a parallel degree DL satisfying the following equation:
$$DL < \frac{PR}{2} \cdot \frac{FO}{RA}$$
where FO is a focal length of the lenses, and RA is a distance between the optical axis of one of the lenses and an inner wall of the aperture corresponding to the one of the lenses.
